(19) United States
(12) Patent Application Publication
(10) Pub. No.: US 2014/0249905 A1
(43) Pub. Date: Sep. 4, 2014

(54) METHOD FOR HANDLING ELECTRONIC VOUCHERS

(71) Applicant: Oliver C. Mehler, Bodman-Ludwigshafen (DE)

(72) Inventor: Oliver C. Mehler, Bodman-Ludwigshafen (DE)

(21) Appl. No.: 14/349,287

(22) PCT Filed: Sep. 11, 2012
(86) PCT No.: PCT/DE2012/200061

§ 371 Date: Apr. 2, 2014

(30) Foreign Application Priority Data
Oct. 4, 2011 (DE) 10 2011 114 638.9
Dec. 14, 2011 (DE) 10 2011 088 614.1

(51) Int. Cl. G06Q 30/02

(52) U.S. Cl. CPC G06Q 30/0238
USPC 705/14.23

(57) ABSTRACT

The invention refers to a method for handling electronic coupons, particularly in the retail and/or service industry, whereby a mobile terminal device, particularly a mobile phone or smartphone is used to pay cashless for one or several products and/or services—products—at a pay terminal, whereby the data to execute the payment process/the payment are preferably transmitted wirelessly between the mobile terminal device and the payment terminal via near field communication (NFC), whereby a receipt with regard to the paid products is transmitted to the mobile terminal device, whereby using the receipt information on the receipt the mobile terminal device preferably sends a request to the central database, whereby the database processes the request, whereby the database provides an electronic coupon for a coupon product depending on the receipt information transmitted in the request and whereby the electronic coupon is automatically redeemed when paying for the coupon product.

### CROSS REFERENCE TO RELATED APPLICATIONS

This application is a national stage application, filed under 35 U.S.C. §371, of International Application No. PCT/DE2012/200061, filed Sep. 11, 2012, which claims priority to German Application No. 10 2011 114 638.9, filed Oct. 4, 2011 and German Application No. 10 2011 088 614.1, filed Dec. 14, 2011, all of which are hereby incorporated by reference in their entirety.

### BACKGROUND

1. Technical Field

The invention relates to a method of processing electronic coupons, particularly in retail and/or service businesses.

2. Description of Related Art

Today, retail and service businesses face enormous cutthroat competition. Particularly manufacturers in the consumer goods segment try with permanent product innovations to take customers from each other and to keep them loyal for as long as possible. In this context, it is difficult for manufacturers to get consumers to change their purchasing habits and to try something new or different.

Therefore, to gain customers paper-based rebate systems or methods have been known in practice for years. In the known method, paper-based rebate coupons are handed out for a certain product at the cash register. In this particular case, after paying at the cash register either in cash or by card, one or several discount vouchers are printed in addition to the receipt and handed to the customer together with the receipt. The discount voucher can be printed on the back of the receipt. When shopping later, the customer can redeem this coupon only from the same business. The coupon is good for a certain product or a product from a specific assortment. In general, this discounted product competes or is used for a similar need as the products purchased and paid for earlier. To receive the discounted price for the purchase of the product on the coupon, the product printed on the coupon must be purchased and the coupon must be redeemed.

To carry out in practice this known rebate method, the enterprise or rebate grantor has to have a database with the currently valid rebate campaigns. After a payment transaction of the customer or rebate taker, for example in cash or by card, a database request with regard to the purchased products is triggered by the cash register system or an enterprise resource planning (ERP) system connected with the cash register system. The database responds potentially with rebate information, which in turn can be printed out at the cash register by a printer. One problem with the known method is the expenses incurred by the high quantity of required consumables and the necessity of a printer at the cash register. Furthermore, the known method is highly inefficient and cumbersome due to its characteristics such as removal and handing out of coupon, coupon redemption and collection, change of printing paper, etc.

### BRIEF SUMMARY

The task of this present invention is to design and advance a method for handling electronic coupons of the type specified above so that it is possible to handle coupons simply, effectively and cost-efficiently.

### DETAILED DESCRIPTION OF VARIOUS EMBODIMENTS

The above-referenced task is solved by claim 1 of this invention. Accordingly, a method to handle electronic coupons, particularly in the retail and/or service industry, is needed, whereby a mobile terminal device, particularly a mobile phone or smartphone is used to pay cashless for one or several products and/or services at a pay terminal, whereby the data to execute the payment process/the payment are preferably transmitted wirelessly between the mobile terminal device and the payment terminal via near field communication (NFC), whereby a receipt with regard to the paid products is transmitted to the mobile terminal device, whereby using the receipt information on the receipt the mobile terminal device preferably sends a request to the central database, whereby the database processes the request, whereby the database provides an electronic coupon for a coupon product depending on the receipt information transmitted in the request and whereby the electronic coupon is automatically redeemed when paying for the coupon product.

In accordance with the present invention, it has been recognized that it is a significant benefit if handling coupons is combined with cashless payment for products, i.e. of goods or services. In this particular case, a mobile terminal device such as a mobile phone or smartphone is used for paying cashless for at least one product at a payment terminal. During this process, the data to execute payment are transmitted wirelessly or contactlessly, preferably per near field communication technology between the mobile terminal device and the payment terminal. In a second step, an electronic receipt for the paid products is transmitted to the mobile terminal device. By using the receipt information gathered by the receipt, the mobile terminal device transmits a request preferably to a central database, which processes the request and which provides an electronic coupon for a coupon product depending on the receipt information transmitted with the request. In this context, depending on the receipt information means that a coupon will be provided, if a predefined coupon is stored in the database for the transmitted receipt information. During the customer's next purchase, namely when paying for this coupon product, this coupon is preferably redeemed automatically.

In addition, coupons can be redeemed at other businesses, i.e. coupons are not necessarily bound to the business that has issued the receipt.

Therefore, the method in accordance with the invention ensures a simple, effective and cost-efficient handling of electronic coupons.

In this advantageous manner, the information on the receipt can comprise product codes, which allows identifying the paid products on the receipt. For example, as product codes of the purchased products, GTIN, EAN, UPC and/or item level codes can be specified on the receipt.

In another advantageous manner, the electronic coupon can be linked in the database beforehand to at least one of the product codes of the paid product. Therefore, in the database a product code is assigned to a predefined electronic coupon, which can be provided to the customer by the mobile terminal device upon respective database search.

In an advantageous embodiment, the electronic coupon can comprise a product code and/or a rebate amount with regard to the coupon product. The rebate amount can be transmitted in different ways. On the one hand, it is conceivable that the amount is sent by the database system—similar to a bank transfer—to the cash register system or to an account of the retailer, so that in this manner the retailer receives the regular price. On the other hand, the customer or rebate beneficiary could pay the full amount to the retailer and the rebate will be credited by the database system to an account specified by the customer. Such an account could be a bank account, a virtual internet account such as PayPal, a bonus point account, a credit card account or “digital wallet” or e-wallet, which is similar to cashless and which is in the mobile terminal device.

Furthermore, the coupon can comprise a coupon identification code. Within the framework of the customer using or redeeming the coupon, it is conceivable that a security request is triggered to check the validity of the coupon for plausibility purposes, for example by transmission of the coupon identification code, or perhaps additional information such as the product code of the coupon product, the rebate amount or the validity date. The security request can be carried out by the mobile terminal device or the cash register system.

In an actual embodiment, the electronic coupon can comprise an advertising message, a product review and/or information with regard to the coupon product. The advertising message, product review and information with regard to the coupon product could be linked to the respective product code of the coupon product in the database. The advertising message can be in text form, in numerical form, in graphic form, animated or a combination thereof. With regard to the product review, it is conceivable that this product review includes only reviews of purchasers of the coupon product. For this purpose, a program installed on the mobile terminal device could allow reviewing the products listed on the receipts. This way only users who have actually purchased the product, review the product. These reviews can be stored in the database and perhaps offered together with the electronic coupon. With regard to additional information about the coupon product, it is conceivable that product locations of the coupon product are provided together with the electronic coupon. Therefore, a function is conceivable for the mobile terminal device on which the coupon product was purchased with the coupon that points, based on the location of the mobile terminal device or its user, automatically to the vicinity where the coupon product can be purchased for a particularly inexpensive price. This would give the user potentially a double savings opportunity. In addition, this function could be implemented for the products listed on the electronic receipt to enable the user of the mobile terminal device to compare prices of the user's favorite products without any additional effort. For this purpose, third parties such as retailers authorized by the database operator could supply current price and location information to the product codes. In general, the electronic coupon can also have a link to an advertising message, product reviews and/or additional information with regard to the coupon product.

In an actual embodiment, the validity of the electronic coupon can be limited, whereby the limitation can be comprised of a minimum quantity that must be purchased, a maximum of permissible coupons for the coupon product in the terminal device, a maximum number of coupons that can be redeemed at one time, a cumulative minimum purchase volume of a predefined product before the coupon can be redeemed and/or with regard to a transferability of the coupon. By requiring a cumulative minimum purchase volume of a predefined product, exclusively shoppers who habitually buy a product that competes with the coupon product could be made aware of the coupon product. Furthermore, the coupon could be restricted in time, by region and/or by retailer.

With regard to the provision of the electronic coupon, the electronic coupon can be transmitted from the database to the mobile terminal device.

In a particularly advantageous embodiment, the electronic coupon can be transferred to a user account of a person utilizing the rebate, which is preferably stored on a central server. The coupons can be collected in the user account of the person utilizing the rebate and, therefore, they do not necessarily have to be stored in the mobile terminal device. Thus it would be possible to have, for example, only a link in the mobile terminal device, specifically a database link, pointing to the electronic coupon. Therefore, the person utilizing the rebate can access the coupons with several, different terminal devices. This is particularly beneficial for rebate users with several terminal devices or for families for which several family members use the same user account and who would like to share the collected coupons.

With regard to effective and comfortable handling of coupons on the mobile terminal device, several electronic coupons can be managed through one program on the mobile terminal device, by which the electronic coupons can for example be viewed, sorted, deleted, sent, analyzed and/or reviewed. Therefore, the customer or rebate taker can browse through, sort, transfer or delete his or her collected and perhaps already redeemed coupons and retrieve statistics or make basic settings. As a setting option, it is conceivable to define, for example, a minimum rebate amount for acceptable coupons and to eliminate automatically any “spam” coupons with a value of e.g. only 1 cent. Furthermore, it is conceivable to define a minimum validity for acceptable coupons or to configure the account for the transfer of the rebate amount. With regard to the transfer of the rebate amount, it is furthermore conceivable that the debit account for debiting during the payment process at the cash register is different than the credit account for the rebates.

In another advantageous embodiment, the definition and/or administration of the electronic coupon in the database can be managed through an administration account by a rebate grantor. Therefore, the rebate grantor can store or allocate electronic coupons in the database to certain product codes through the administration account.

In a particularly advantageous embodiment, the rebate grantor receives through the database a comprehensive analysis function with regard to the use of the provided electronic coupons to analyze the effectiveness of the rebate campaign preferably in real time.

In an actual embodiment, the electronic coupon on the mobile terminal device can be displayed as identification code, specifically in form of alphanumeric characters, a 1-D, 2-D and/or QR code. Therefore, the electronic coupon can also be used or redeemed at retailers with cash register systems that do not support electronic payment transactions. For this purpose, the identification code is displayed on the terminal device and then transmitted by manual entry or automatic scanning into the cash register system. However, in this case, the settlement of the coupon in the database must be processed through the cash register system and not the mobile terminal device.

In another advantageous embodiment, the receipt can be transmitted from the payment terminal to the mobile terminal device within the framework of the payment process.

Furthermore, with regard to the transmission of the receipt during the payment process, destination address information can be transmitted to the payment terminal to address the mobile terminal device, whereby the receipt will be transmitted through the destination address information to the mobile terminal device by an electronic transmission method such as by e-mail, messenger, SMS, MMS, etc. In this particular case, a cash register system is connected to the payment terminal. If it is not possible to transmit the electronic receipt to the mobile terminal device by way of the contactless payment terminal, then it is conceivable that it can be transmitted by another electronic means by the cash register system stating a unique device or user identification code, which would be retransmitted during the payment transaction. In this context, a detour could be chosen by e.g. sending the receipt first to the central database, which in turn would forward it to the mobile terminal device or to the user account.

With regard to handling receipts comfortably, several receipts can be managed through a program on the mobile terminal device, whereby the receipts and/or the paid products included on the receipts can be viewed, sorted, deleted, sent, analyzed and/or reviewed specifically. With regard to the review of the purchased products, it is highly beneficial that only purchasers of the products can review the products.

In a particularly advantageous embodiment, the information on the receipt can comprise a receipt identification code. After the electronic coupon was provided, the link between the receipt identification code and the product code can therefore be marked in the database in a manner that no new coupon can be issued to this link to exclude any undesired multiple use.

Now there are numerous options for the advantageous embodiments and advancements of the method of the present invention. On the one hand, reference is made to patent claims subordinated to patent claim 1 and on the other hand, to the following explanation of an example of a preferable embodiment of the invention. In connection with the explanation of the preferable embodiment example of the invention, preferable embodiments and advancements of the method are generally explained.

In an actual embodiment of the method in accordance with the invention, the receipt is transmitted electronically to the mobile terminal device via secure connection after the payment transaction with a mobile terminal device such as an NFC-ready smartphone. This is carried out directly via the wireless payment terminal to the mobile terminal device. In addition to the standard possible information on the receipt such as product name, quantity, price, taxes, retailer and receipt identification code(s), the receipt also contains the respective product codes such as GTIN, EAN, UPC, and perhaps even the item level codes of the purchased products. The receipt is managed in a program installed on the mobile terminal device. In this context, even receipts that were perhaps transmitted by detour such as by mail or SMS can be “checked-in,” i.e. accepted to be further processed for rebate coupon requests to the database.

The program on the mobile terminal device establishes a secure connection to a central database and it sends a request to the database specifying a receipt identification number and one or several product codes. If the request result is positive, the returned reply can consist of one or several rebate coupons in electronic form. These can be managed on the mobile terminal device through the program. It enables the user to browse through, sort, transmit or delete his or her gathered and perhaps already used coupons and the user can retrieve statistics and define basic settings such as a minimum rebate amount, a minimum validity date for accepted coupons or the user can configure account settings for the transfer of the rebate amount.

The central database allows linking further information in addition to the rebate coupon to the product code and transmitting this information to the mobile terminal device upon request. For example, information about customer satisfaction ratings of products allocated to a specific product code can be linked, which can be displayed on the mobile terminal device. In the mobile terminal device, the satisfaction of the user can be requested as well (e.g. “four stars”) or a link to social networks (“I like”) can be established to provide this information to other users. In addition, prose texts about the experiences made with the coupon product purchased with the coupon can be entered and displayed. Because it is possible that a customer e.g. purchases the coupon product on the coupon for the first time and he or she may want to know beforehand how satisfied others are with this coupon product or the purchaser may want to let others know how satisfied he or she is after the purchase. Receipts stored on the mobile terminal device can be dealt with in an analogous manner, i.e. in addition to the products listed on the electronic receipt, there is the option to display the review of other users or for a user to provide his or her review. Among others, these reviews can then be viewed by recipients of coupons for these products.

The advantage of this method is that products can only be reviewed by those users who have purchased these products. Therefore, so-called “fake reviews” are excluded.

After the rebate coupon is transmitted to the mobile terminal device, the corresponding link consisting of receipt identification number and product code are marked within the database in a manner such that subsequently, it is impossible to transmit a new coupon to this link to avoid any undesired multiple use.

In general, the product code of the rebate coupon sent by the database will differ from the product code of the product requested from the database.

In addition to the product code, the rebate amount, a unique coupon identification code (code) and perhaps an advertising message (e.g. as text, graphic design, animated or a combination thereof), a rebate coupon can also include a series of additional information such as a link to additional information about the discounted product or limitations with regard to the coupon's validity such as restrictions in time, by region or by retailer, minimum purchase quantities, a maximum number of coupons that can be redeemed for a specific product at the same time, the maximum number of coupons permissible for a specific product in the mobile terminal device, permissible transferability of the coupon to other terminal devices or users, the definition of a minimum purchase quantity of advertised products before a coupon will be issued in order to be able to make only the habitual purchaser aware of the manufacturer's own product.

The data for this purpose, perhaps only a link to these data, are stored in a central database and linked to the corresponding product code.

After setting up the user account, the rebate grantor such as the brand manufacturer or retailer can access the central database (“merchant platform”) and can issue coupons for any product code or store and manage any consumer-relevant additional information. In addition, it can define limitations and/or retrieve statistics on the effectiveness of the rebate campaign. If the database operator limits the issue of several rebate coupons for the same product issued at the same time by different rebate grantors, then the rebate grantor has the option to specify the highest fee the grantor would be willing to pay for a priority similar to automated auction processes.

Within the framework of customers using rebate coupons, it is conceivable that a security request is sent to the database to check the validity of the coupon, for example by transmitting the coupon identification code, perhaps additional information such as product code, amount or date of validity for the plausibility check. This request can be carried out by the mobile terminal device or by the cash register system.

The rebate amount can be transferred in several manners. On the one hand, the database system can send the amount to the cash register system or the bank account of the retailer—similar to a bank transfer—paying the retailer its regular price. On the other hand, the customer can pay full price to the retailer and the database system can issue a credit for the rebate to an account specified by the customer. Such account can be a bank account, a virtual internet account (such as PayPal), a bonus point account, a credit card account or an account similar to a “digital wallet” located in the mobile phone.

It is conceivable that the program includes a function that can lead to a recall of any rebate that has already been paid, for example, if a product purchased for a discount has been returned after the purchase.

After the rebate coupon has been successfully redeemed, the administration account of the rebate grantor can be debited in the amount of the coupon, potentially together with a processing fee, and the rebate coupon can be marked as “redeemed.” Therefore, the mere handing out of an electronic rebate coupon does not necessarily lead to a (fee) debit of the stored administration account of the rebate grantor but only after the customer redeems the coupon.

Rebate grantors can be provided comprehensive analysis functions through the database in order to review the effectiveness of the rebate campaign in real time.

If a purchased product additionally has a unique item level code, then this item level code can be scanned at the cash register and added to the electronic receipt, so that it can potentially be linked to the rebate coupon corresponding to the identification code in the database, i.e. the coupon identification code. This way, any potential abuse of the process can be limited, if e.g. rebated products are purchased and later returned for reimbursement of the full list price. Upon return, the item level code can again be scanned and sent to the database. It enables the database to check whether and to which user account the rebate has been paid and perhaps initiate a return of the paid rebate. Furthermore, the item level codes allow providing the user perhaps additional useful information such as merchandise tracking information (tracing) or information about the authenticity o f the product.

Furthermore, a function will be provided for the mobile terminal device that allows the user to view first any transmitted electronic rebate coupons and then these must be accepted by the user at the push of a button to allow an automatic redemption later. In this manner, attention is drawn to the product purchased with the coupon and the intended advertising message is conveyed more effectively.

All data connections between the cash register system or payment terminals, mobile terminal devices, database and rebate grantor are secured against unauthorized manipulation.

With regard to other advantageous embodiments of the method in accordance with the invention, reference is made to the general part of the description and the annexed patent claims to avoid any repetition.

Finally, it is expressly pointed out that the above-referenced example of an embodiment of the method in accordance with the invention serves the explanation of the method used; however, this method is not limited to the embodiment example.

1-16. (canceled)

17. Method to handle electronic coupons, said method comprising the step of using a mobile terminal device to pay cashless for one or several products or services at a payment terminal, wherein:
a mobile terminal device is used to pay cashless for one or several products and/or services—products—at a payment terminal;
the data to execute the payment transaction or payment is transmitted wirelessly between the mobile terminal device and the payment terminal;
a receipt with regard to the purchased products is transmitted to the mobile terminal device;
the mobile terminal device sends a request to a database based at least in part upon and containing information located on the receipt;
the database processes the request;
the database provides an electronic coupon for a coupon product based on the receipt information transmitted with the request; and
the electronic coupon is redeemed when paying for the product or service.

18. Method in accordance with claim 17, wherein the mobile terminal device is at least one of a mobile phone or a smartphone.

19. Method in accordance with claim 17, wherein the information on the receipt includes a product code.

20. Method in accordance with claim 19, wherein the product code is at least one of a GTIN, a EAN, a UPC, or an item level code of the purchased product.

21. Method in accordance with claim 17, wherein the electronic coupon is linked beforehand in the database by at least one of the product codes to the purchased products.

22. Method in accordance with claim 17, wherein the electronic coupon includes at least one of a product code, a rebate amount or a coupon identification code.

23. Method in accordance with claim 17, wherein the electronic coupon comprises at least one of an advertising message, a product review, or information with regard to the coupon product.

24. Method in accordance with claim 17, wherein the electronic coupon contains a limitation with regard to its validity, whereby this limitation refers to at least one of a minimum quantity to be purchased, in the terminal device a maximum number of coupons permitted for the coupon product, a maximum number of coupons that can be redeemed at the same time, a cumulative minimum purchasing volume of a predefined product before the coupon can be redeemed, or the transferability of the coupon.

25. Method in accordance with claim 17, wherein the electronic coupon is transmitted to the mobile terminal device.

26. Method in accordance with claim 17, wherein the electronic coupon is transmitted to a user account stored on a central server.

27. Method in accordance with claim 17, wherein several electronic coupons can be managed through a program installed on the mobile terminal device, whereby the electronic coupons can especially be at least one of viewed, sorted, deleted, sent, analyzed, or reviewed.

28. Method in accordance with claim 17, wherein the definition and/or administration of the electronic coupon in the database is managed by a rebate grantor through an administration account.

29. Method in accordance with claim 17, wherein the database provides the rebate grantor an analysis function with regard to the use of the provided electronic coupons.

30. Method in accordance with claim 17, wherein the electronic coupon is displayed on the mobile terminal device as an identification code.

31. Method in accordance with claim 30, wherein the identification code comprises at least one of a string of alphanumeric characters, a 1-D code, a 2-D code, or a QR code.

32. Method in accordance with claim 17, wherein the receipt is transmitted to the mobile terminal device by the payment terminal during the payment transaction.

33. Method in accordance with claim 17, wherein destination information to address the mobile terminal device is transmitted to the payment terminal during the payment transactions, whereby the receipt will be transmitted through the destination address information to the mobile terminal device by an electronic transmission method such as at least one of e-mail, messenger, SMS, or MMS.

34. Method in accordance with claim 17, wherein several receipts can be managed on the mobile terminal device through a program, whereby the receipts and/or the products purchased and included on the receipt can be at least one of viewed, sorted, deleted, sent, analyzed, or reviewed.

35. Method in accordance with claim 17, wherein the information on the receipt includes a receipt identification code.

36. Method in accordance with claim 17, wherein the electronic coupon is handled, via the method, in at least one of the retail or the service industry.

37. Method in accordance with claim 17, wherein the wireless transmission between the mobile terminal device and the payment terminal occurs via near field communication (NFC) transmission technology.

38. Method in accordance with claim 17, wherein the database is centrally located.

39. Method in accordance with claim 17, wherein the electronic coupon is redeemed automatically when paying for the product or service.
